(19) United States
(12) Patent Application Publication
(10) Pub. No.: US 2009/0120600 A1
(43) Pub. Date: May 14, 2009

(54) Nano carbon crystal material and method of manufacturing electrothermal board by using the same

(76) Inventors: Ching-Ling Pan, Hsin Chuang City (TW); Yung-Shun Wu, Sanchong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,855

(22) Filed: Nov. 9, 2007

(51) Int. Cl. D21H 13/10; B32B 9/00

(52) U.S. Cl. 162/146; 428/367

(57) ABSTRACT

The present invention discloses a nano carbon crystal material and a method of manufacturing electrothermal board using the same, which is a crystal material and a method of using the facial heat generating body to overcome the present existing problems related to even temperature rise and heat dissipation at the surface of the carbon fiber electrothermal board, poor contact between the carbon fiber and the conducting band, poor insulation, and short life expectancy. The nano carbon crystal material is composed of acrylonitrile-based carbon fibers occupying 70˜80% of the total weight, nano carbon fibers occupying 1˜5% of the total weight and carbon crystals occupying 15˜29% of the total weight. After the nano carbon crystal material is mixed with a paper pulp and an adhesive is added, the electrothermal board produced under pressurized conditions will have the advantages of high stability, fast temperature rise, good insulation, and long life. In addition, the method of manufacturing the electrothermal board is simple, easy, and convenient, and thus is suitable for mass production to satisfy the requirements of production as well as our daily life.

### BACKGROUND OF THE INVENTION

1. Field of the Invention

The present invention relates to a nano carbon crystal material and a method of manufacturing electrothermal board using the same, and more particularly to a crystal material and a method of manufacturing a facial heating body by using the crystal material.

2. Description of the Related Art

Carbon fiber is a high performance material with excellent electrical and thermal conductivity, and its cost becomes increasingly lower, and thus extensive applications are developed in the areas of our daily life. However, most of the present carbon fiber electrothermal boards for preserving temperature and keeping warm have the following issues:

1. Since an improper carbon fiber is selected, the texture is loose and soft, and the paper pulp is mixed to form coagulated lumps. As a result, the temperature rise and heat dissipation at the surface of the pressed complex product are uneven, and deformations or burned spots will occur easily.

2. Since a gap formed between the carbon fiber and the conducting band causes a poor contact, an electric arc will be produced easily after an electric connection, so that the carbon fiber paper and the board connected to an electrode may be scraped due to the result of punctures.

3. The carbon fiber material leaks a large quantity of current in a salt mist or wet working environment, and thus its use jeopardizes the safety of our lives.

The aforementioned issues affect the extensive use of carbon fiber electrothermal boards in our daily life.

### SUMMARY OF THE INVENTION

It is a primary object of the invention to provide a nano carbon crystal material and a method of manufacturing an electrothermal board by using the nano carbon crystal material to overcome the shortcomings of the prior art, such as the temperature rise and heat dissipating at the surface of the carbon fiber electrothermal board are uneven, the carbon fiber and the conducting band have a poor contact, the insulation is poor, and the working life is short.

The carbon crystal is described briefly here. Under certain conditions, carbon is a very good semiconductor material. Theoretically, each monomer has an anode and a cathode no matter how many particles is cut and divided from carbon. In fact, most carbon particles do not have these features. In special manufacturing methods (such as the ball milling, softening, purification and extraction processes conducted at high temperature and high pressure) by a modified carbon material for extracting pure large mesh carbon crystals, and a large quantity of carbon crystals perform Brownian motion under the effect of electric fields to rub and oscillate with each other to produce a large quantity of heat, so as to convert electric energy into heat energy.

The nano carbon crystal material consists of acrylonitrile-based carbon fibers, occupying 70˜80% of the total weight of the nano carbon crystal material; nano carbon fibers, occupying 1˜5% of the total weight of the nano carbon crystal material; and carbon crystals, occupying 15˜29% of the total weight of the nano carbon crystal material. The acrylonitrile-based carbon fiber is composed of acrylonitrile-based carbon fibers having a number of thousand-filaments of 10˜15K, a diameter of 1˜5 μm, and a length of 2˜4 mm and 4.5˜6 mm respectively, and formed according to the ratio of 0.5˜2:1 by weight; and the diameter of the nano carbon fiber is 50˜200 nm; and the number of meshes of the carbon crystal mesh is 400˜1000 meshes.

A method of manufacturing an electrothermal board by using the above-mentioned nano carbon crystal material includes the steps of:

1. preparing a nano carbon crystal heat-generating paper;

a. setting a ratio of the weight of the nano carbon crystal material and the weight of the paper pulp for making paper to be 1:9˜19, and mixing the nano carbon crystal material into the paper pulp for making paper, and then adding water solution into a dispersant to form a mixed carbon fiber pulp, wherein the consuming quantity of the dispersant is equal to 0.5˜5% of the weight of the nano carbon crystal material;

b. adding the mixed carbon fiber pulp into a high-speed isotropic machine containing a water soluble adhesive solution and blended at a speed of 800˜2000 rpm for 1˜2 hours, so that the degree of beating of the pulp falls within a range of 35°˜55° SR;

c. using a paper making machine having a 50-mesh paper marking net to control the paper marking machine at a speed of 10˜15 m/min for processing the processed carbon fiber mixed pulp, and then compressing the carbon fibers on a piece of woolen cloth, and drying and shaping the carbon fibers by a baking bobbin;

2. preparing a glass fiber cloth prepreg: applying the mixed paint onto the surface of a fiber cloth with over 25×16 transverse and longitudinal glass fibers, wherein the mixed paint has a proportion of phenolic resin, epoxy resin and acetone mixture equal to 1˜5:4˜8:1 by weight to obtain a glass fiber cloth prepreg with a thickness of 0.1˜0.3 mm;

3. preparing a nano carbon crystal electrothermal board;

d. placing six layers of 50-gram Kraft paper on an iron tray first, and then placing a leveling iron plate with a thickness of 1˜3 mm, and finally coating a mold release agent on the iron plate;

e. coating a layer of a high pressure resisting polyethylene film of 0.01˜0.05 mm thick on the iron plate, and placing a piece of decoration paper on the high pressure resisting polyethylene film;

f. laying 3˜5 layers of fiber cloth prepregs on the decoration paper, and then putting a piece of nano carbon crystal paper, and putting a copper foil wrapped with tin foil separately on both sides as conducting electrode;

g. laying 3˜5 layers of fiber cloth prepregs on the nano carbon crystal paper;

h. laying a layer of the high pressure resisting polyethylene film of 0.01˜0.05 mm thick on the fiber cloth prepreg, and coating a mold release agent thereon, and then laying a leveling iron plate of 1˜3 mm thick on the high pressure resisting polyethylene film, and then laying 6 layers of 50-gram Kraft paper on the iron plate;

i. securing the flat copper meshed conducting wire with the copper electrode as conducting anode and cathode, and leading them parallelly from the backside of the glass fiber cloth prepreg; and

j. putting the semi-finished product on a thermal press machine, and preheating it up to 80° C., and turning on the thermal press machine to pressurize up to 200 tons and increase the temperature up to 100° C., and keep the constant temperature and pressure for 8˜9 minutes, and then increase the temperature to 120° C., and keep the constant temperature and pressure for 8˜9 minutes, and then increase the temperature to 140° C., and keep the constant temperature and pressure for 8˜9 minutes and then lower the temperature to 55° C. while keeping the pressure constant, and then reduce the pressure and temperature to room temperature, and finally open the mold to get the nano carbon crystal electrothermal board.

In addition, the dispersant is composed of sodium alginate, methyl cellulose, polyacrylamine or any combination of the above. The paper pulp for making paper is a wood cellulose pulp. The water soluble adhesive is composed of polyaniline, polyvinyl alcohol, water soluble phenolic resin or any combination of the above. The mold release agent is a polyurethane mold release agent.

Carbon crystals are used for lattice vibrations to generate heat, and acrylonitrile-based carbon fiber materials with different aspect ratios form the connecting wires of the lattices. Adding nano carbon fibers not only reduces the occurrence of electrostatic dissipations and sparks, and also guarantees the heat dissipation of the lattices that are contacted with each other or separated with a distance equal to several atomic diameters, and the nano carbon crystal material is constituted of a three-dimensional network with transversal and longitudinal intersections of points, lines and planes for moving carriers in this network along the direction towards a low electric potential. As to the microscopic view, nano carbon crystals are partially disordered, but as to the macroscopic view, nano carbon crystals are totally ordered. Carbon crystals can form an even facial heat-generating surface, and thus the surface of an electrothermal board made of a nano carbon crystal material comes with even temperature rise and heat dissipation.

Therefore, the present invention an electrothermal board made of a nano carbon crystal material, and the electrothermal board is a whole facial heat dissipating board whose conductor is a facial heat-generating surface formed by carbon fibers with a three-dimensional network which is partially disordered, totally ordered, and cut into different lengths. The electrothermal board can produce far infrared rays of 8˜10 μm, and a long time of use provides a health care effect to users In addition, electrothermal boards are rigid, safe and highly insulated, and usually come with a puncture voltage of 10000V, a long life that will not break or fall off after a continuous use of over 30000 hours, and moisture-proof and waterproof features, and thus the electrothermal boards are suitable for the application of keeping warm at home, heating a bathing pool, drying clothes, offices, meeting rooms or hotels.

Further, the electrothermal board manufactured by the method of the present invention features the advantages of having an even stable heat generating performance, a quick temperature rise, an excellent insulating function, and a long working life, and thus such electrothermal board is suitable for mass production to satisfy production requirements and our daily needs, and the manufacturing method is simple, easy and convenient to operate.

### BRIEF DESCRIPTION OF THE FIGURES

FIG. 1 is a schematic view of a distribution of temperature detection points in accordance with Embodiment 10 of the present invention;

FIG. 2 is a curve of a room air temperature that varies with time;

FIG. 3 is a curve of an average temperature of a carbon crystal electrothermal board that varies with time; and

FIG. 4 is a curve of the quantity of heat at the surface of a carbon crystal electrothermal board that varies with time.

### DETAILED DESCRIPTION OF THE PREFERRED EMBODIMENT

To make it easier for our examiner to understand the objective of the invention, its structure, innovative features, and performance, we use the following preferred embodiments together with the attached drawings for the detailed description of the invention.

### Embodiment 1

The nano carbon crystal material is composed of acrylonitrile-based carbon fibers occupying 70˜80% of the total weight, nano carbon fibers occupying 1˜5% of the total weight, and carbon crystals occupying 15˜29% of the total weight, wherein the acrylonitrile-based carbon fibers have a number of thousand-filaments of 10˜15K, a diameter of 1˜5 μm, and lengths of 2˜4 mm and 4.5˜6 mm respectively, and a weight ratio of 0.5˜2:1. In addition, the diameter of the nano carbon fibers is 50˜200 nm, and the number of carbon crystal meshes is equal to 400˜1000 meshes.

The processing method is carried out according to the following reactions:

1. Mix the acrylonitrile-based carbon fibers occupying 70˜80% of the total weight, the nano carbon fiber occupying 1˜5% of the total weight, and the carbon crystals occupying 15˜29% of the total weight;

2. Add the mixture into a clean container that contains an acetone solution with a mass concentration of 10˜30%, and blend the mixtures at a speed of 300˜600 rpm, and dip and soften the mixture for one hour;

3. The blended solution goes through an ultrasonic cleaning for 0.5˜2 hours (for removing impurities and keep the surface clean and free of glues);

4. The cleaned solution is heated until the acetone is vaporized completely to obtain the nano carbon crystal material.

### Embodiment 2

The difference between this embodiment and Embodiment 1 is that the nano carbon crystal material is composed of acrylonitrile-based carbon fibers occupying 72˜78% of the total weight, nano carbon fibers occupying 2˜4% of the total weight, and carbon crystals occupying 18˜25% of the total weight, and the rest is the same as Embodiment 1.

### Embodiment 3

The difference between this embodiment and Embodiment 1 is that nano carbon crystal material is composed of acrylonitrile-based carbon fibers occupying 75% of the total weight, nano carbon fibers occupying 3% of the total weight, and carbon crystals occupying 20% of the total weight, and the rest is the same as Embodiment 1.

### Embodiment 4

The difference between this embodiment and Embodiment 1 is that the diameter of acrylonitrile-based carbon fibers is 2˜4 μm, and the rest is the same as Embodiment 1.

### Embodiment 5

The difference between this embodiment and Embodiment 1 is that the diameter of acrylonitrile-based carbon fibers is 3 μm, and the rest is the same as Embodiment 1.

### Embodiment 6

The difference between this embodiment and Embodiment 1 is that the diameter of nano carbon fibers is 80˜150 nm, and the rest is the same as Embodiment 1.

### Embodiment 7

The difference between this embodiment and Embodiment 1 is that the diameter of nano carbon fibers is 100 nm, and the rest is the same as Embodiment 1.

### Embodiment 8

The difference between this embodiment and Embodiment 1 is that the carbon crystal mesh is 600˜900 meshes, and the rest is the same as Embodiment 1.

### Embodiment 9

The difference between this embodiment and Embodiment 1 is that the carbon crystal mesh is 800 meshes, and the rest is the same as Embodiment 1.

### Embodiment 10

The method of manufacturing an electrothermal board by using the nano carbon crystal material produced by Embodiment 1 comprises the following steps:

1. Prepare a nano carbon crystal heat-generating paper:

a. The ratio of the weight of the nano carbon crystal material and the weight of the paper pulp for making paper is 1:9˜19. Mix the nano carbon crystal material into the paper pulp for making paper, and then add water solution into a dispersant to form a mixed carbon fiber pulp, and the consuming quantity of the dispersant is equal to 0.5˜5% of the weight of the nano carbon crystal material. The dispersant is composed of sodium alginate, methyl cellulose, polyacrylamine or any combination of the above, and the paper pulp for making paper is a wood cellulose pulp.

b. Add the carbon fiber mixed pulp into a high-speed isotropic machine that contains a water soluble adhesive solution, and blend the pulp at a speed of 800˜2000 rpm for 1˜2 hours until the degree of beating of the pulp is in the range of 35°˜55° SR. The water soluble adhesive is composed of polyaniline, polyvinyl alcohol, water soluble phenolic resin or any combination of the above.

c. The processed carbon fiber mixed pulp goes through a paper making machine having a 50-mesh paper marking net to control the paper marking machine at a speed of 10˜15 m/min, and then the carbon fibers are compressed on a piece of woolen cloth, dried and shaped by a baking bobbin, cut by a cutting equipment, tested by bulk module measuring device, and finally the carbon crystal content of a large roll of nano carbon crystal heat-generating paper is selected to meet the product requirements of the paper, and the paper is cut into a shape according to the product requirement.

2. Prepare the glass fiber cloth prepreg: Apply the mixed paint onto the surface of a fiber cloth with over 25×16 transverse and longitudinal glass fibers, and the mixed paint has a proportion of phenolic resin, epoxy resin and acetone mixture equal to 1˜5:4˜8:1 by weight to obtain a glass fiber cloth prepreg with a thickness of 0.1˜0.3 mm, and the phenolic resin is a phenolic resin 1411, and the epoxy resin is an epoxy resin E44.

3. Prepare the nano carbon crystal electrothermal board:

d. Place six layers of 50-gram Kraft paper on an iron tray first, and then place a leveling iron plate with a thickness of 1˜3 mm, and finally coat a mold release agent on the iron plate. The mold release agent is a polyurethane mold release agent.

e. Coat a layer of a high pressure resisting polyethylene film of 0.01˜0.05 mm thick on the iron plate, and place a piece of decoration paper on the high pressure resisting polyethylene film.

f. Lay 3˜5 layers of fiber cloth prepregs on the decoration paper, and then put a piece of nano carbon crystal paper, and put a copper foil wrapped with tin foil separately on both sides as conducting electrodes, wherein the copper foil has a width of 10˜15 mm, and a thickness of 0.6 mm, and then use an edge knurling machine to press both sides to form meshes (and the purpose of the pressed marks it to keep the tin foil, copper foil and carbon crystal paper in full contact.

g. Lay 3˜5 layers of fiber cloth prepregs on the nano carbon crystal paper.

h. Lay a layer of the high pressure resisting polyethylene film of 0.01˜0.05 mm thick on the fiber cloth prepreg, and coat a mold release agent thereon, wherein the mold release agent is a polyurethane mold release agent, and then lay a leveling iron plate of 1˜3 mm thick on the high pressure resisting polyethylene film, and then lay 6 layers of 50-gram Kraft paper on the iron plate.

i. Secure the flat copper meshed conducting wire with the copper electrode as conducting anode and cathode, and lead them parallelly from the backside of the glass fiber cloth prepreg.

j. Put the semi-finished product on a thermal press machine, and preheat it up to 80° C., and turn on the thermal press machine to pressurize up to 200 tons and increase the temperature up to 100° C., and keep the constant temperature and pressure for 8˜9 minutes, and then increase the temperature to 120° C., and keep the constant temperature and pressure for 8˜9 minutes, and then increase the temperature to 140° C., and keep the constant temperature and pressure for 8˜9 minutes and then lower the temperature to 55° C. while keeping the pressure constant, and then reduce the pressure and temperature to room temperature. Finally, open the mold to get the nano carbon crystal electrothermal board.

In this embodiment, the heat-generating paper has a basis weight of 30˜70 g/m², a thickness of 60˜80 μm; both upper and lower layers of the Kraft paper provide a pressure reducing and buffering effect; if the dispersant is a mixture, the different dispersants can be mixed according to any proportion; if the water soluble adhesive is a mixture, different water soluble adhesives can be mixed according to any proportion; the phenolic resin in the fixed paint is a curing agent; the epoxy resin is an adhesive, and the acetone solution is a thinner.

The experiments below demonstrate the effect of the aforementioned embodiments of the invention:

The experiments were conducted in a temperature controlled chamber with international standard, and the chamber has no heat source inside out and provides an almost 100% heat insulating effect, and the net dimensions of the interior of the chamber include: a floor of (3.93±0.2 m)×(3.93±0.2 m), a height of 2.8±0.2 m, 16 pieces of nano carbon crystal electrothermal boards of (600 mm×900 mm) on the floor of the chamber 16, and all nano carbon crystal electrothermal boards are connected in series.

Testing Condition The nano carbon crystal electrothermal board is placed horizontally in the standard chamber, and the edge of the electrothermal board is kept 0.3 m from the wall and set at the middle.

Testing Apparatuses: Thermal couple for measuring temperature, galvanometer, temperature indicating meter, voltmeter, ammeter, anemometer, humidity meter, and watt-hour meter.

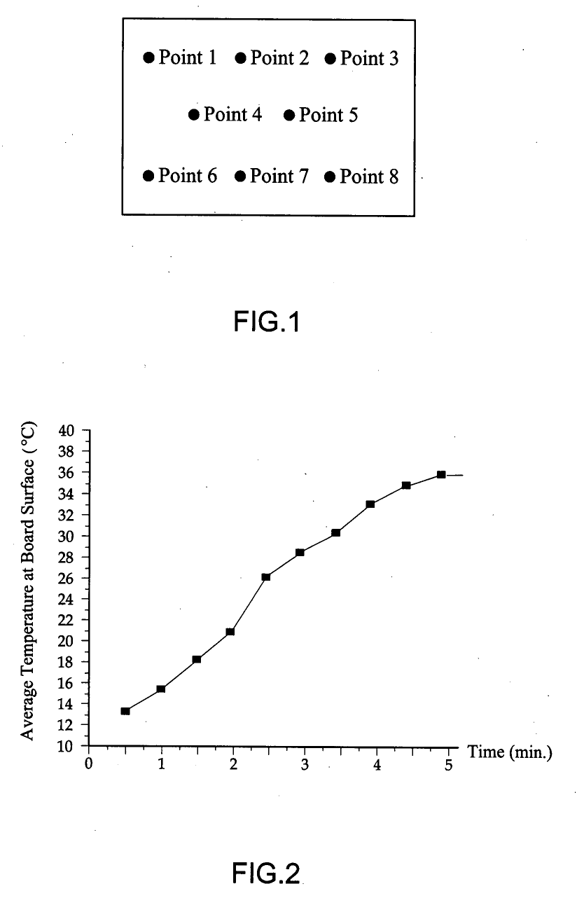

In any selected electrothermal board, eight temperature detection points are set on the surface of the selected electrothermal board as shown in FIG. 1, and set in the standard chamber without cold or hot sources such as air conditioners, and close to absolutely insulating. If the room temperature is at 12.5° C., the nano carbon crystal electrothermal board is electrically conducted to continue measuring the temperature. From the measuring results listed in Table 1 (that shows the measurements of temperature at each measuring point of the electrothermal board while the temperature is rising and Table 2 (that shows that temperature of each measuring point of the electrothermal board after the temperature is stable, regardless of the condition of a temperature rise as shown in Table 1 or a stable process as shown in Table 2, the temperature of each measuring point of the electrothermal board is uniform, and close to an isothermal field, and each measuring time and the average difference between the maximum temperature and minimum temperature fall within a range of 0.5˜2.5° C.

TABLE 1

| | Temperature (° C.) | | | | | | | |
|---|---|---|---|---|---|---|---|---|
| Time (hr) | Point 1 | Point 2 | Point 3 | Point 4 | Point 5 | Point 6 | Point 7 | Point 8 |
| 10 | 13.20 | 13.34 | 13.40 | 13.50 | 13.27 | 13.84 | 13.56 | 13.89 |
| 30 | 13.94 | 14.17 | 15.65 | 15.45 | 16.01 | 15.88 | 16.05 | 15.34 |
| 50 | 16.36 | 17.77 | 18.02 | 17.32 | 18.10 | 18.13 | 16.67 | 17.85 |
| 70 | 17.22 | 18.17 | 17.39 | 19.33 | 19.02 | 17.37 | 18.29 | 18.63 |
| 90 | 21.74 | 23.27 | 24.09 | 25.17 | 21.29 | 23.34 | 24.18 | 22.31 |
| 110 | 24.38 | 25.36 | 26.22 | 24.19 | 26.32 | 27.01 | 26.89 | 24.59 |
| 130 | 28.69 | 28.83 | 28.90 | 30.11 | 31.31 | 29.61 | 30.42 | 31.04 |
| 150 | 33.23 | 33.91 | 33.29 | 34.37 | 35.11 | 34.74 | 35.26 | 34.29 |
| 180 | 36.12 | 36.37 | 36.22 | 37.09 | 37.82 | 36.32 | 37.19 | 38.10 |
| 200 | 37.89 | 38.09 | 39.24 | 39.73 | 40.05 | 39.28 | 39.21 | 40.13 |
| 220 | 38.89 | 39.02 | 40.56 | 40.28 | 42.35 | 42.79 | 39.37 | 39.37 |
| 240 | 41.28 | 42.37 | 39.98 | 39.74 | 42.13 | 42.29 | 41.29 | 39.86 |
| 280 | 41.69 | 42.10 | 40.06 | 39.89 | 42.07 | 42.19 | 41.37 | 39.88 |
| 300 | 42.22 | 42.02 | 39.88 | 39.90 | 42.08 | 42.10 | 41.35 | 39.70 |

TABLE 2

| | Temperature (° C.) | | | | | | | |
|---|---|---|---|---|---|---|---|---|
| Time (hr) | Point 1 | Point 2 | Point 3 | Point 4 | Point 5 | Point 6 | Point 7 | Point 8 |
| 1 | 41.28 | 42.37 | 39.98 | 39.74 | 42.13 | 42.29 | 41.29 | 39.66 |
| 2 | 41.69 | 42.10 | 40.06 | 39.89 | 42.07 | 42.19 | 41.37 | 39.88 |
| 3 | 42.22 | 42.02 | 39.88 | 39.90 | 42.08 | 42.10 | 41.35 | 39.70 |
| 4 | 42.28 | 42.27 | 39.78 | 39.94 | 42.23 | 42.19 | 41.39 | 39.76 |
| 5 | 42.19 | 42.19 | 40.06 | 39.89 | 42.17 | 42.29 | 41.27 | 39.58 |
| 6 | 42.02 | 42.01 | 39.78 | 39.80 | 42.08 | 42.20 | 41.15 | 39.60 |

In the standard chamber at a room temperature of 12.5° C. as shown in Table 2, after the nano carbon crystal electrothermal board is electrically conducted, the average surface temperature of 16 pieces of electrothermal board varies with time, and it shows that the average surface temperature of the electrically conducted board rises rapidly, and the average surface temperature of the 16 boards reaches an appropriate temperature 36° C. within 4.4 minutes for the construction requirements on ground.

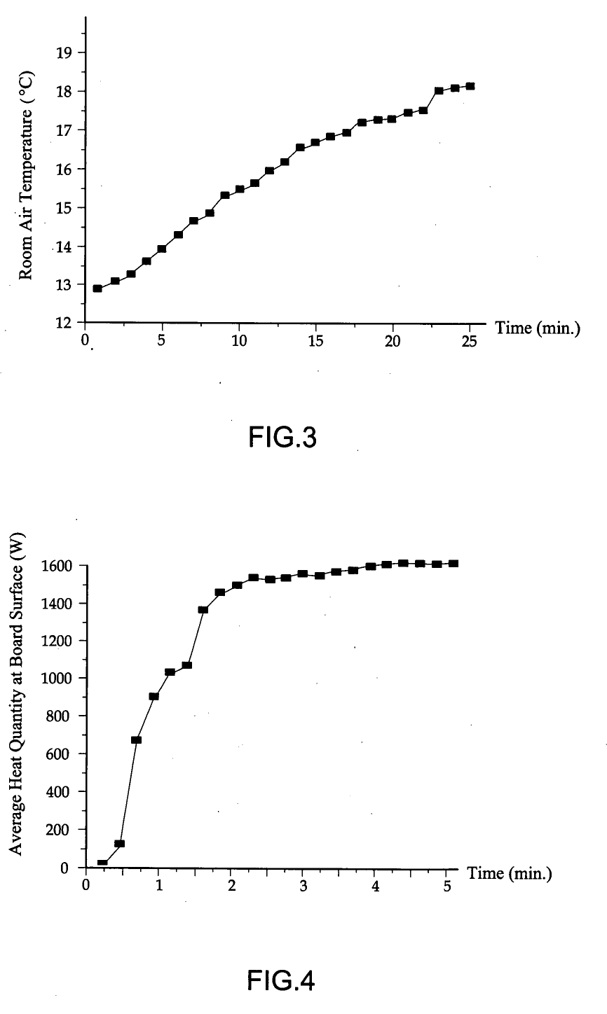

In an electrically conducted electrothermal board as shown in FIG. 3, the room air temperature in the chamber varies with time, and it shows that the nano carbon crystal electrothermal board can dissipate heat into air rapidly, so that it only takes 23.2 minutes for the room temperature to rise quickly to the standard temperature of 18° C.

After the electrothermal board is electrically conducted as shown in FIG. 4, the curve of the average heating generating quantity of the 16 pieces of boards varying with time indicates that the quantity of generated heat of the electrically conducted electrothermal board increases rapidly. After 4.3 minutes, the quantity of generated heat reaches its maximum, and remains unchanged thereafter.

### Embodiment 11

The difference between this embodiment and Embodiment 10 is that the ratio of the weight of the nano carbon crystal material and the weight of the paper pulp for making paper is 1:12˜17, and the rest is the same as Embodiment 10.

### Embodiment 12

The difference between this embodiment and Embodiment 10 is that the ratio of the weight of the nano carbon crystal material and the weight of paper pulp for making paper is 1:15, and the rest is the same as Embodiment 10.

### Embodiment 13

The difference between this embodiment and Embodiment 10 is that the proportion of the weight of the phenolic resin, the weight of the epoxy resin and the weight of the acetone is 3:6:1, and the rest is the same as Embodiment 10.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A nano carbon crystal material, comprising:
acrylonitrile-based carbon fibers, occupying 70˜80% of the total weight of the nano carbon crystal material;
nano carbon fibers, occupying 1˜5% of the total weight of the nano carbon crystal material; and
carbon crystals, occupying 15˜29% of the total weight of the nano carbon crystal material.

2. The nano carbon crystal material of claim 1, characterized in that the nano carbon crystal material is composed of acrylonitrile-based carbon fibers occupying 72˜78% of the total weight, nano carbon fibers occupying 2˜4% of the total weight, and carbon crystals occupying 18˜25% of the total weight.

3. The nano carbon crystal material of claim 1 or 2, wherein the acrylonitrile-based carbon fiber is composed of acrylonitrile-based carbon fibers having a number of thousand-filaments of 10˜15K, a diameter of 1˜5 μm, and a length of 2˜4 mm and 4.5˜6 mm respectively, and formed according to the ratio of 0.5˜2:1 by weight; and the diameter of the nano carbon fiber is 50˜200 nm; and the number of meshes of the carbon crystal mesh is 400˜1000 meshes.

4. A method of manufacturing an electrothermal board by using the nano carbon crystal material as recited in claim 1, comprising the steps of:
1. preparing a nano carbon crystal heat-generating paper;
a. setting a ratio of the weight of the nano carbon crystal material and the weight of the paper pulp for making paper to be 1:9˜19, and mixing the nano carbon crystal material into the paper pulp for making paper, and then adding water solution into a dispersant to form a mixed carbon fiber pulp, wherein the consuming quantity of the dispersant is equal to 0.5˜5% of the weight of the nano carbon crystal material;
b. adding the mixed carbon fiber pulp into a high-speed isotropic machine containing a water soluble adhesive solution and blended at a speed of 800˜2000 rpm for 1˜2 hours, so that the degree of beating of the pulp falls within a range of 35°˜55° SR;
c. using a paper making machine having a 50-mesh paper marking net to control the paper marking machine at a speed of 10˜15 m/min for processing the processed carbon fiber mixed pulp, and then compressing the carbon fibers on a piece of woolen cloth, and drying and shaping the carbon fibers by a baking bobbin;
2. preparing a glass fiber cloth prepreg: applying the mixed paint onto the surface of a fiber cloth with over 25×16 transverse and longitudinal glass fibers, wherein the mixed paint has a proportion of phenolic resin, epoxy resin and acetone mixture equal to 1˜5:4˜8:1 by weight to obtain a glass fiber cloth prepreg with a thickness of 0.1˜0.3 mm;
3. preparing a nano carbon crystal electrothermal board;
d. placing six layers of 50-gram Kraft paper on an iron tray first, and then placing a leveling iron plate with a thickness of 1˜3 mm, and finally coating a mold release agent on the iron plate;
e. coating a layer of a high pressure resisting polyethylene film of 0.01˜0.05 mm thick on the iron plate, and placing a piece of decoration paper on the high pressure resisting polyethylene film;
f. laying 3˜5 layers of fiber cloth prepregs on the decoration paper, and then putting a piece of nano carbon crystal paper, and putting a copper foil wrapped with tin foil separately on both sides as conducting electrode;
g. laying 3˜5 layers of fiber cloth prepregs on the nano carbon crystal paper;
h. laying a layer of the high pressure resisting polyethylene film of 0.01˜0.05 mm thick on the fiber cloth prepreg, and coating a mold release agent thereon, and then laying a leveling iron plate of 1˜3 mm thick on the high pressure resisting polyethylene film, and then laying 6 layers of 50-gram Kraft paper on the iron plate;
i. securing the flat copper meshed conducting wire with the copper electrode as conducting anode and cathode, and leading them parallelly from the backside of the glass fiber cloth prepreg; and
j. putting the semi-finished product on a thermal press machine, and preheating it up to 80° C., and turning on the thermal press machine to pressurize up to 200 tons and increase the temperature up to 100° C., and keep the constant temperature and pressure for 8˜9 minutes, and then increase the temperature to 120° C., and keep the constant temperature and pressure for 8˜9 minutes, and then increase the temperature to 140° C., and keep the constant temperature and pressure for 8˜9 minutes and then lower the temperature to 55° C. while keeping the pressure constant, and then reduce the pressure and temperature to room temperature, and finally open the mold to get the nano carbon crystal electrothermal board.

5. The method of manufacturing an electrothermal board by using a nano carbon crystal material as recited in claim 4, wherein the dispersant is composed of sodium alginate, methyl cellulose, polyacrylamine or any combination of the above.

6. The method of manufacturing an electrothermal board by using a nano carbon crystal material as recited in claim 4, wherein the paper pulp for making paper is a wood cellulose pulp.

7. The method of manufacturing an electrothermal board by using a nano carbon crystal material as recited in claim 4, wherein the water soluble adhesive is composed of polyaniline, polyvinyl alcohol, water soluble phenolic resin or any combination of the above.

8. The method of manufacturing an electrothermal board by using a nano carbon crystal material as recited in claim 4, wherein the phenolic resin is a phenolic resin 1411, and the epoxy resin is an epoxy resin E44.

9. The method of manufacturing an electrothermal board by using a nano carbon crystal material as recited in claim 4, wherein the copper foil has a width of 10˜15 mm and a thickness of 0.6 mm, and the copper foil is pressed by an edge knurling machine to form meshes on both edges of the copper foil.

10. The method of manufacturing an electrothermal board by using a nano carbon crystal material as recited in claim 4, wherein the mold release agent is a polyurethane mold release agent.
